(19) United States
(12) Patent Application Publication
(10) Pub. No.: US 2006/0219296 A1
(43) Pub. Date: Oct. 5, 2006

(54) Safety machanism of a high-pressure gas outflow control for cutting off gas outflow when the control is broken

(76) Inventor: Hui-Ming Lin, Lucao Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/098,484

(22) Filed: Apr. 5, 2005

(51) Int. Cl. F16K 17/40

(52) U.S. Cl. 137/68.14

(57) ABSTRACT

A safety mechanism includes a connecting tube, a blocking bead, a spring, and a propping pin; the connecting tube having an axial hole, which has a front portion, a rear portion, and a middle portion having the smallest diameter; the rear portion of the connecting tube having an easy-to-break recess portion; the connecting tube is held in an outlet tube of a switch of a gas cylinder at the front portion; the bead is held in the front portion of the hole of the connecting tube; the pin is held in the connecting tube; a gas regulator is connected to the rear portion of the connecting tube, and makes the pin prop the bead off the blocking position and also to compress the spring; when the connecting tube breaks, the spring will bias the pin outwards, and gas will force the bead to block the hole of the connecting tube.

### BACKGROUND OF THE INVENTION

1. Field of the invention

The present invention relates to a safety mechanism of a high-pressure gas outflow control for cutting off gas outflow when the control is broken, more particularly one, which is structured in such a way as to certainly function to cut off outflow of gas from the gas cylinder when the high-pressure gas outflow control is hit and broken accidentally.

2. Brief Description of the Prior Art

Referring to FIG. 1, a conventional high-pressure gas outflow control includes a switch 1, and a gas regulator 2. The switch 1 has a passage 11, a control knob 12, and an outlet tube portion 14, which communicates with the passage 11, and which has internal screw threads 13. The switch 1 is securely connected to an outlet of a gas cylinder so that the passage 11 communicates with inside of the gas cylinder. The control knob 12 can be turned to such a position as to stop outflow of gas from the gas cylinder, and it can be turned away from the stopping position as to allow outflow of gas from the gas cylinder. The gas regulator 2 has a gas conduit 20, and an inlet tube portion 26. A connecting tube 23 and a connecting knob 22 are used to join the gas regulator 2 to the switch 1; the connecting knob 21 has screw threads 22 on an outer side of a connecting section thereof; the connecting tube 23 has a leakage-prevention ring 25 secured around a first end thereof, a mesh filter 251 held therein, and a spring 250, which is held in the connecting tube 25 to make the mesh filter 251 stay in position. The connecting tube 23 is passed into the outlet tube portion 14 of the switch 1 at the first end, and the connecting knob 21 is positioned around the connecting tube 23, and passed into the outlet tube portion 14 such that both the connecting tube 23 and the connecting knob 21 are securely connected to the switch 1, and such that the leakage-prevention ring 25 is tightly pressed against the inner side of the switch 1. The gas regulator 2 is connected to the other end of the connecting tube 23 at the inlet tube portion 26 thereof, and the gas conduit 20 is connected to a gas stove.

The above high-pressure gas outflow control has a disadvantage: after the connecting tube 23 and the inlet tube portion 26 of the gas regulator 2 are joined together, a step-shaped portion 27 will be formed, which is more fragile than other portions of the gas outflow control. Therefore, if the gas cylinder falls over, and the gas outflow control hits other objects in an accident such as an earthquake, the gas outflow control will break at the step-shaped portion 27. Consequently, not only will the gas regulator 2 fail to function to prevent leakage and explosion, the gas regulator 2 will cause undesired outflow of gas from the gas cylinder owing to its breakage as well. Consequently, explosion and fire may happen.

Referring to FIGS. 2 to 4, to overcome the above-mentioned disadvantage, an improvement on the above high-pressure gas outflow control is provided, which includes a switch 1, a gas regulator 2, and a safety mechanism. The switch 1 has a passage 11, a control knob 12, and an outlet tube portion 14, which communicates with the passage 11, and which has internal screw threads 13. The switch 1 is securely connected to an outlet of a gas cylinder. The control knob 12 can be turned to such a position as to stop outflow of gas from the gas cylinder. The gas regulator 2 has an inlet tube portion 26. The safety mechanism includes a propping pin 3, a bead 4, a spring 31, a seat 32, a securing tube 5, a connecting tube 23, and a connecting knob 21; the connecting knob 21 has screw threads 22 on an outer side; the connecting tube 23 has a leakage-prevention ring 25 secured around a first end thereof, a mesh filter 251 held therein, and a spring 250 used to make the mesh filter 251 stay in position. The connecting tube 23 is passed into the outlet tube portion 14 of the switch 1 at the first end, and the connecting knob 21 is positioned around the connecting tube 23, and passed into the outlet tube portion 14 such that both the connecting tube 23 and the connecting knob 21 are securely connected to the switch 1; the bead 4 has a larger diameter than a middle portion 24 of the axial hole of the connecting tube 23, and it is held between the first end and the middle portion 24 of the axial hole of the connecting tube 23; the propping pin 3 is passed through the middle portion 24 of the axial hole of the connecting tube 23; the seat 32 is securely connected to a second end of the propping pin 3 while the spring 31 is held in an outward end portion of the connecting tube 23 and touches the seat 32. The securing tube 5 is securely engaged around the outward end portion of the connecting tube 23 at a first end thereof; thus, the spring 31 is compressed, and the propping pin 3 props the bead 4 apart from the middle portion 24 of the axial hole of the connecting tube 23. In addition, the securing tube 5 has an annular recess 54 on a middle portion thereof therefore the middle portion of the securing tube 5 is more fragile than other portions of the gas outflow control. The gas regulator 2 is connected to a second end of the securing tube 5 at the inlet tube portion 26 thereof. Consequently, the bead 4 doesn't block the axial hole of the connecting tube 23, and gas is allowed to flow through the connecting tube 23 and the gas regulator 2. And, if the gas cylinder falls over, and the gas outflow control hits other objects, and the securing tube 5 breaks at the middle portion in an accident such as an earthquake, as shown in FIG. 5, the spring 31 will push the seat 32 away from the connecting tube 23, and in turn the propping pin 3 moves together with the seat 32 and falls out of the connecting tube 23, and no longer props the bead 4. Consequently, high-pressure gas from the gas cylinder will push the bead 4 in such way that the bead 4 closes the middle portion 24 of the axial hole of the connecting tube 23 to stop outflow of gas from the gas cylinder through the broken gas outflow control, and danger is avoided.

However, if an accident happens to cause the gas outflow control to hit other objects, and the securing tube 5 breaks at the second end, which is connected to the inlet tube portion 26 of the gas regulator 2, instead of at the middle portion, on which the annular recess 54 is formed, as shown in FIG. 5, the safety mechanism can't function to stop gas outflow from the gas cylinder. Consequently, gas will flow out through the connecting tube 23, and explosion and fire may happen. Furthermore, the securing tube 5 may break incompletely when an accident happens to cause the gas outflow control to hit other objects; if the securing tube 5 doesn't break completely, it is possible for the safety mechanism to fail to function to prevent outflow of gas.

### SUMMARY OF THE INVENTION

It is a main object of the invention to provide an improvement on a safety mechanism of a high-pressure gas outflow control to overcome above-mentioned problem.

The safety mechanism of the invention includes a connecting tube, a blocking bead, a spring, and a propping pin. The connecting tube has an axial hole, which has a front portion, a rear portion, and a middle portion having the smallest diameter. The rear portion of the connecting tube has an easy-to-break recess portion, which is easier to break than other portions of the gas outflow control. The connecting tube is held in an outlet tube of a switch of a gas cylinder at the front portion. The bead is held in the front portion of the hole of the connecting tube. The pin is held in the connecting tube. A gas regulator is connected to the rear portion of the connecting tube, and makes the pin prop the bead off the blocking position and also to compress the spring. Thus, when the connecting tube breaks, the spring will bias the pin outwards, and gas will force the bead to block the hole of the connecting tube.

### BRIEF DESCRIPTION OF THE DRAWINGS

The present invention will be better understood by referring to the accompanying drawings, wherein:

FIG. 1 is a partial sectional view of the first conventional high-pressure gas outflow control,

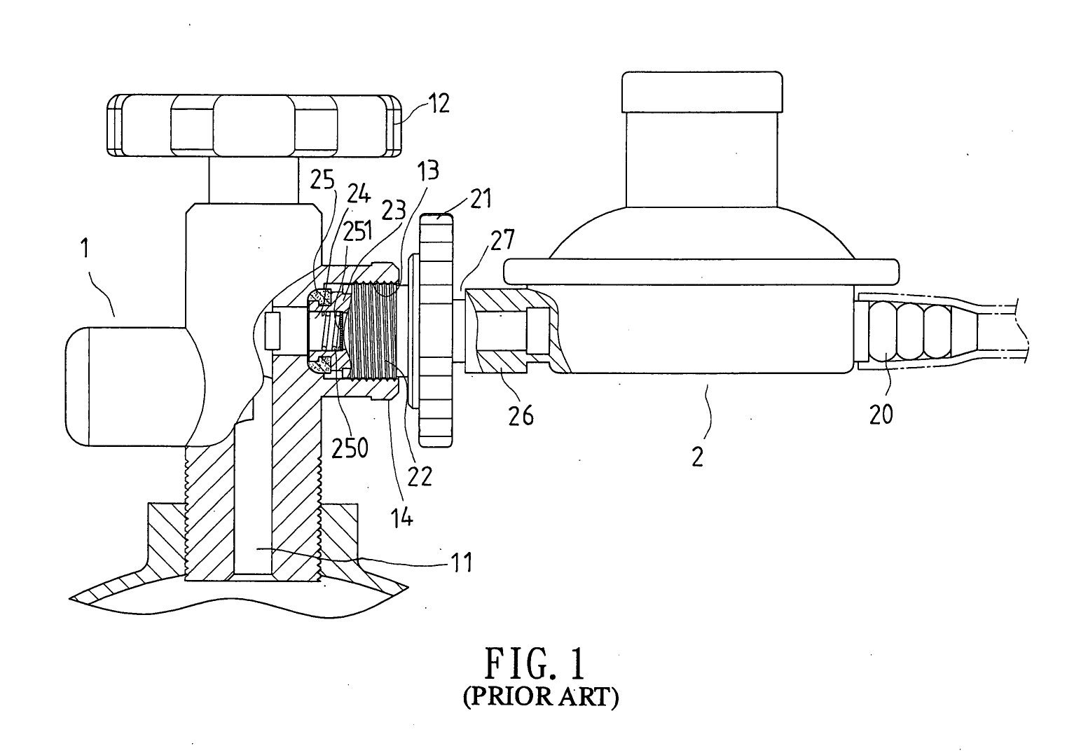

FIG. 2 is an exploded perspective view of the second conventional high-pressure gas outflow control,

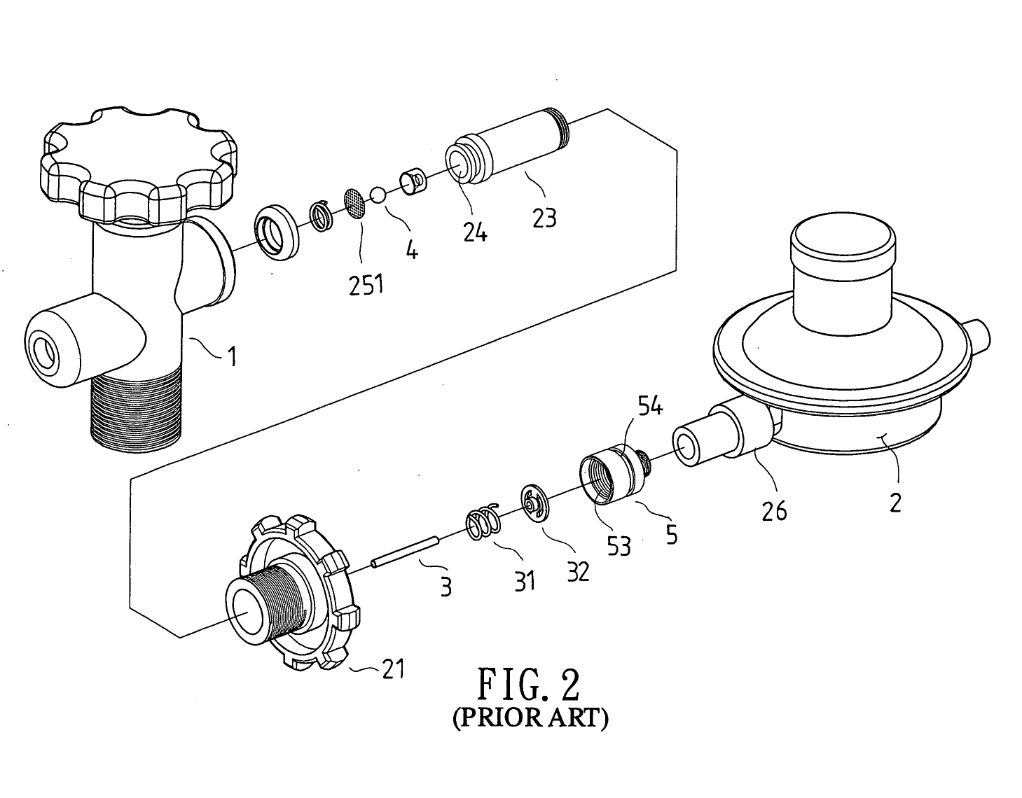

FIG. 3 is a sectional view of the second conventional control,

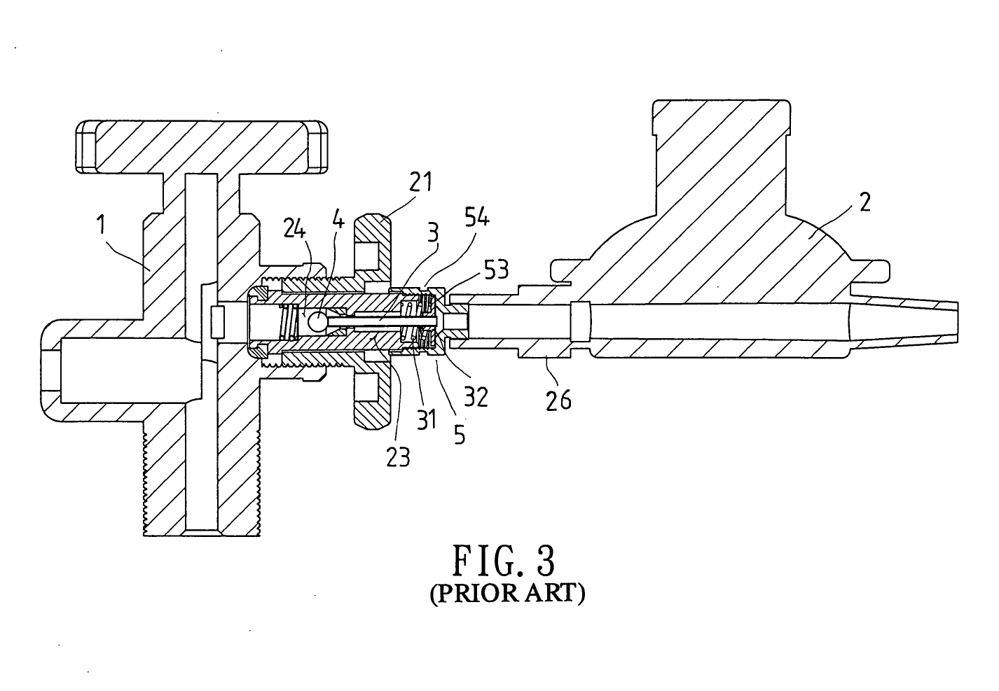

FIG. 4 a sectional view of the second conventional gas outflow control breaking and the safety mechanism functioning,

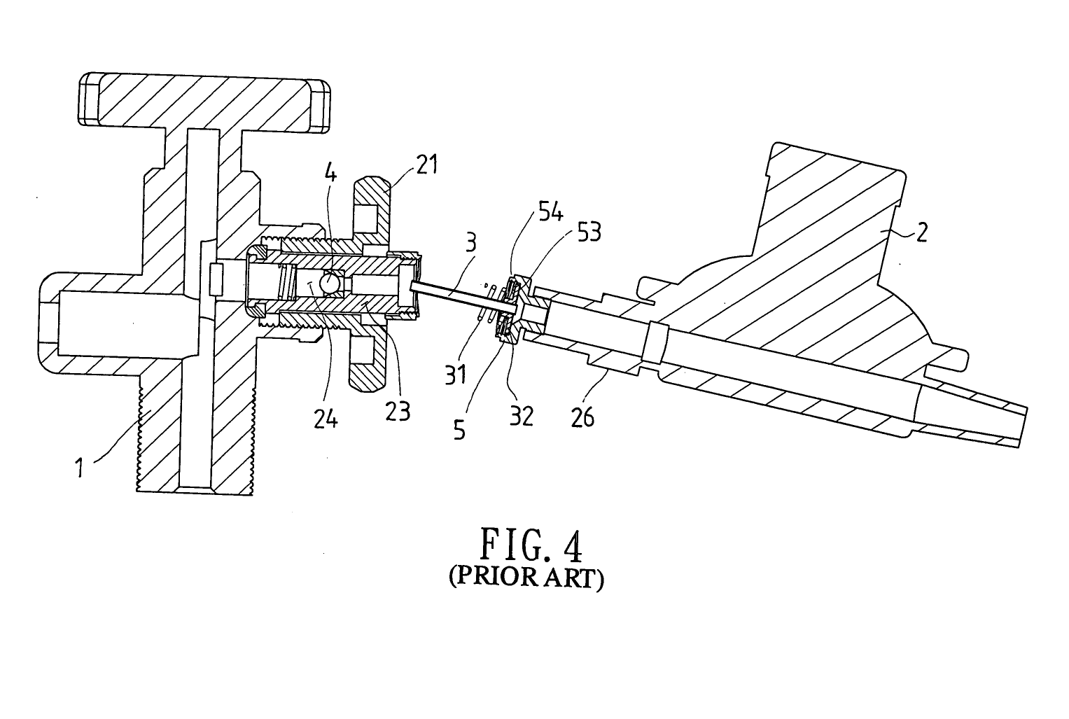

FIG. 5 a sectional view of the second conventional gas outflow control breaking in another way,

FIG. 6 is an exploded perspective view of the high-pressure gas outflow control according to the present invention,

FIG. 7 is a view of the connecting tube of the invention,

FIG. 8 is a sectional view of the present invention, and

FIG. 9 is a sectional view of the gas outflow control being broken and the safety mechanism functioning according to the invention.

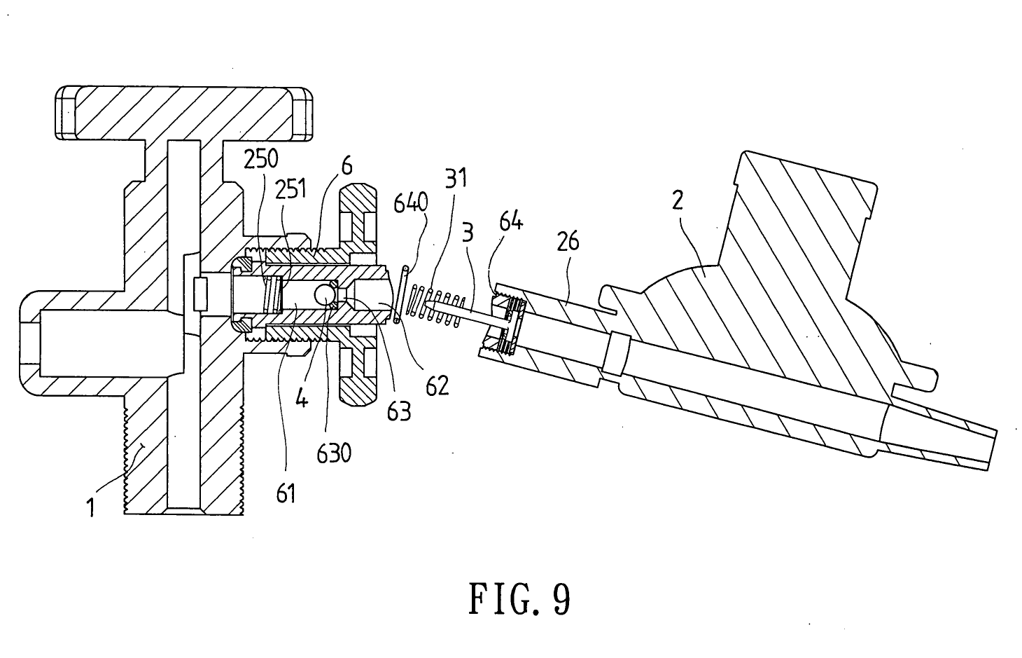

### DETAILED DESCRIPTION OF THE PREFERRED EMBODIMENTS

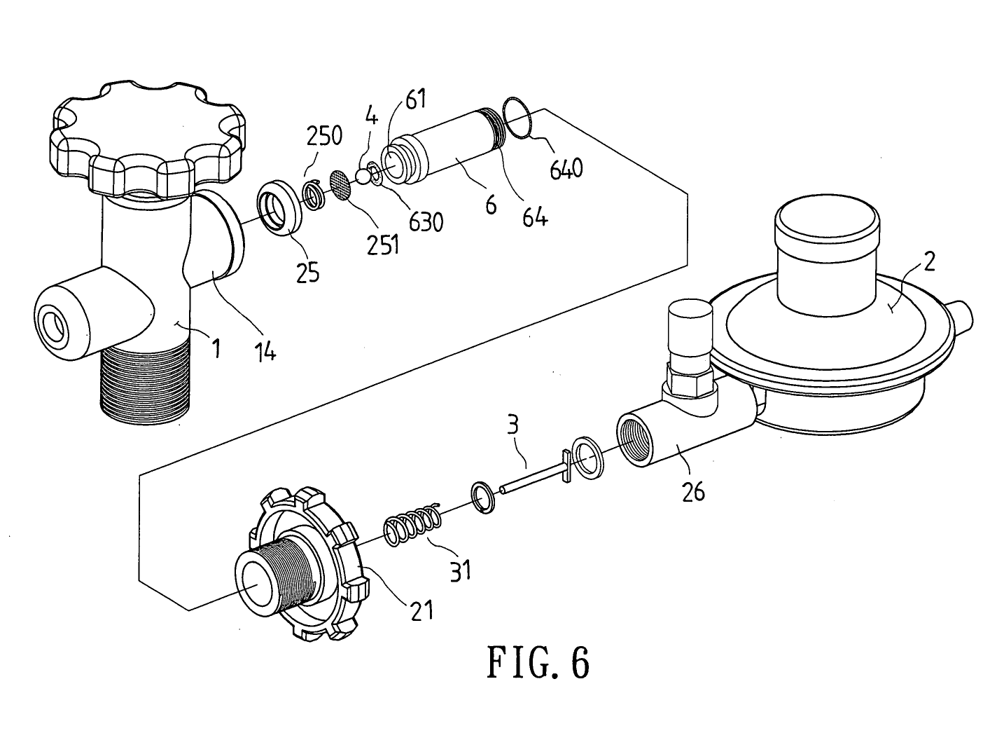

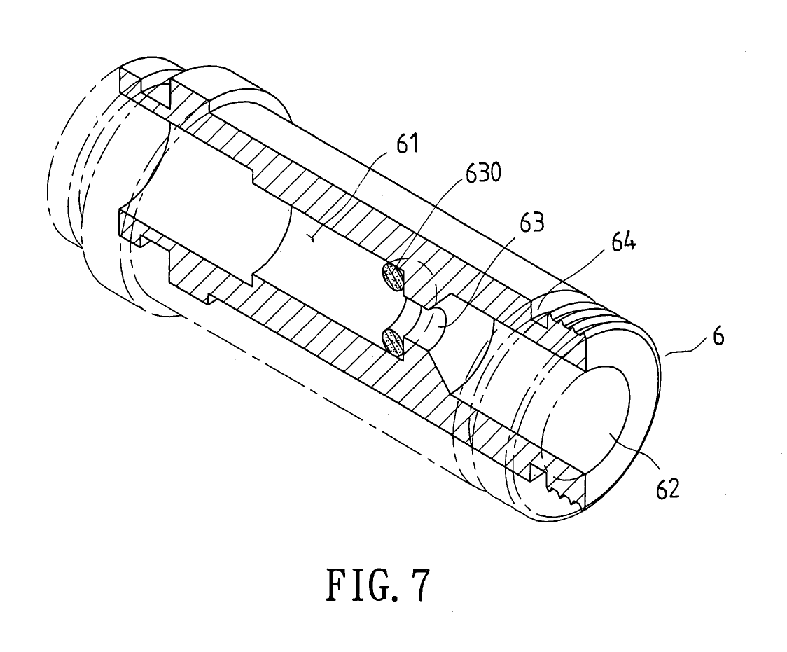

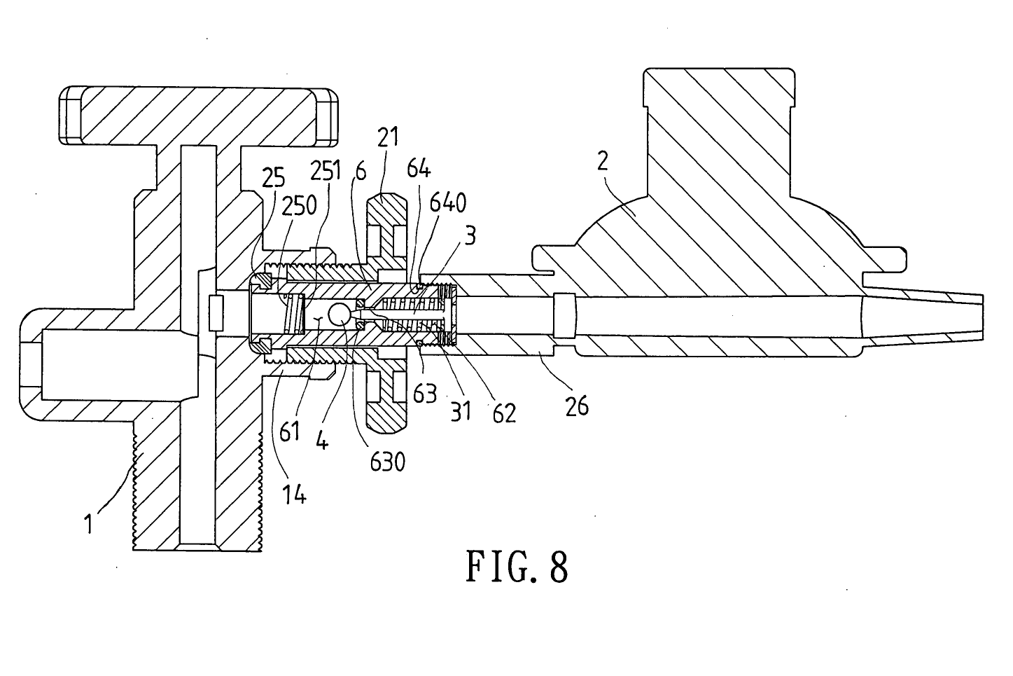

Referring to FIGS. 6, 7, and 8, a preferred embodiment of a high-pressure gas outflow control includes a switch 1, a gas regulator 2, and a safety mechanism, which is used for cutting off gas outflow when the control is broken.

The switch 1 has a passage 11, a control knob 12, and an outlet tube portion 14 communicating with the passage 11. The switch 1 is securely connected to an outlet of a gas cylinder. The outlet tube portion 14 has internal screw threads 13. The control knob 12 is used to adjust outflow of gas through the switch 1, and it can be turned to such a position as to stop outflow of gas from the gas cylinder.

The safety mechanism includes a propping pin 3, a bead 4, a spring 31, a connecting tube 6, and a connecting knob 21; the connecting knob 21 has a connecting section, and threads 22 on an outer side of the connecting section.

The connecting tube 6 has a leakage-prevention ring 25 secured around a first end thereof, and an axial hole, which has a front end portion 61, a rear end portion 62, and a middle portion 63. Furthermore, a rear end portion of the connecting tube 6 has a recess portion 64, on which an annular trench is formed; the recess portion 64 of the connecting tube 6 is more fragile than other parts of the gas outflow control, and the connecting tube 6 certainly will break at the recess portion 64 if it hits other objects in such a way as to break. And, the connecting tube 6 has a mesh filter 251 held in the front end portion 61 of the axial hole, and a spring 250 used to make the mesh filter 251 stay in position. The middle portion 63 of the axial hole of the connecting tube 6 has a smaller diameter than the bead 4. The connecting tube 6 is passed into the outlet tube portion 14 of the switch 1 at the front end portion 61 thereof, and the connecting knob 21 is positioned around the connecting tube 6, and threadedly engaged with the outlet tube portion 14 of the switch 1 at the connecting section thereof such that the connecting tube 6 is secured to the switch 1, and the leakage-prevention ring 25 is tightly pressed against the inner side of the switch 1.

The bead 4 is held in the front end portion 61 of the axial hole of the connecting tube 6. The spring 31 is held in the rear end portion 62 of the axial hole of the connecting tube 6. The propping pin 3 is hollow, and has a protrusion at a rear end, the length of which protrusion is larger than the diameter of the spring 31. The propping pin 3 is passed through the spring 31 and the middle portion 63 of the axial hole of the connecting tube 6 at a front end portion; thus, when the spring 31 is free to stretch to project out from the connecting tube 6 after having been compressed in the connecting tube 6, it will exert force on the propping pin 3 to bias the propping pin 3 outwardly of the connecting tube 6, and in turn the propping pin 3 will fall out of the connecting tube 6.

The gas regulator 2 has an inlet tube portion 26, and the other end portion for connection with a gas oven while the connecting tube 6 has a seal ring 640 positioned on the annular trench of the recess portion 64 thereof. The gas regulator 2 is threadedly engaged around the rear end portion of the connecting tube 6 at the inlet tube portion 26 thereof such that the inlet tube portion 26 is tightly pressed against the seal ring 640, and such that the spring 31 is compressed in the rear end portion of the connecting tube 6, and the propping pin 3 is forced to prop the bead 4 apart from the middle portion 63 of the axial hole of the connecting tube 6 by the gas regulator 6. Consequently, the bead 4 doesn't block the axial hole of the connecting tube 6, and gas is allowed to flow through the connecting tube 6 and the gas regulator 2.

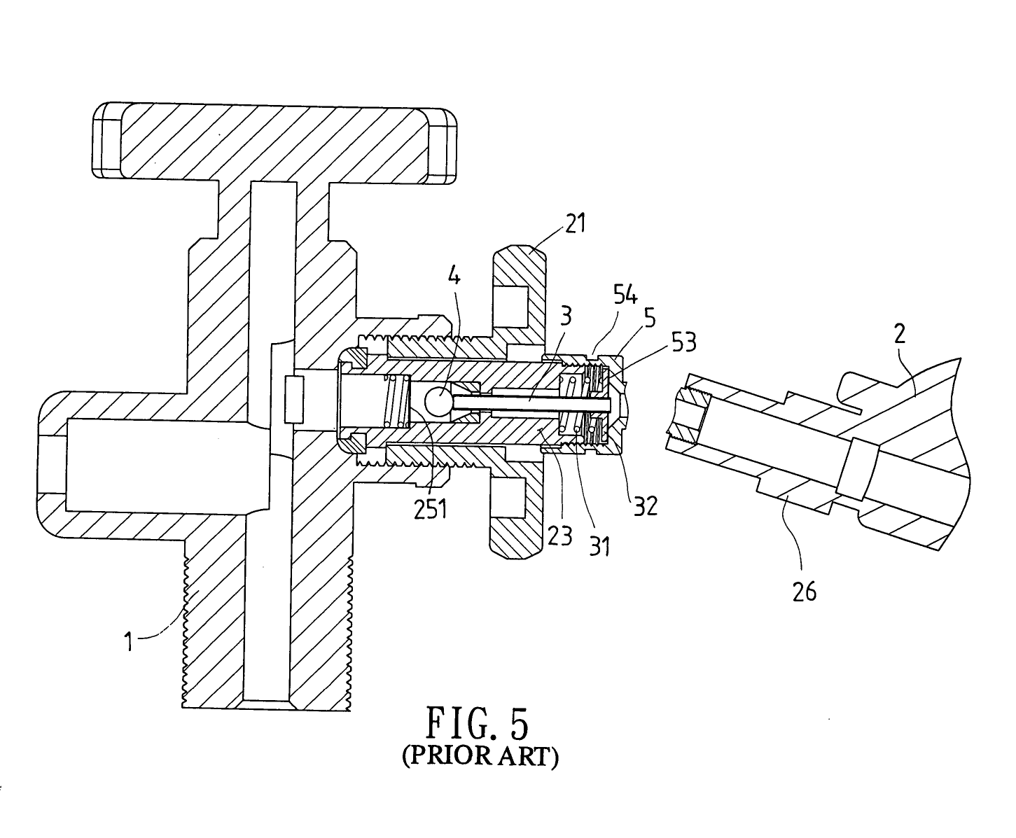

If the gas cylinder falls over, and the gas outflow control hits other objects to get damaged in an accident such as an earthquake, as shown in FIG. 5, the control will only break at the recess portion 64 of the connecting tube 6. The spring 31 will push the propping pin 3 out of the connecting tube 6 as soon as the recess portion of the connecting tube 6 breaks; thus, the propping pin 3 no longer props the bead 4. Consequently, high-pressure gas from the gas cylinder will push the bead 4 in such a way that the bead 4 closes the middle portion 63 of the axial hole of the connecting tube 6 to stop outflow of gas through the broken gas outflow control, and danger is avoided.

From the above description, it can be easily understood that the safety mechanism of the present invention is easy to fit in position, and it has a relatively simple structure when compared with the conventional one. And, the safety mechanism certainly will function to prevent outflow of gas from the gas cylinder as soon as the high-pressure gas outflow control is hit and broken.

What is claimed is:

1. A safety mechanism of a high-pressure gas outflow control, comprising
a connecting tube; the connecting tube having an axial hole, which has a front end portion, a rear end portion, and a middle portion; the rear end portion of the connecting tube having a easy-to-break recess portion, on which an annular trench is formed, and which is easier to break than other portions of the gas outflow control; the connecting tube having a mesh filter held in the front end portion of the axial hole thereof; the connecting tube being held in an outlet tube portion of a switch of a gas cylinder at the front end portion thereof;
a connecting knob; the connecting knob having a connecting section, which has threads on an outer side; the connecting knob being positioned around the connecting tube and threadedly engaged with the outlet tube portion of the switch at the connecting section thereof;
a bead held in the front end portion of the axial hole of the connecting tube for blocking the axial hole of the connecting tube; the bead having a larger diameter than the middle portion of the axial hole of the connecting tube;
a spring held in the rear end portion of the axial hole of the connecting tube; and
a propping pin passed through the spring and the middle portion of the axial hole of the connecting tube; a gas regulator being securely connected to the rear end portion of the connecting tube at an inlet tube portion thereof in such a way as to make the propping pin prop the bead apart from the middle portion of the axial hole of the connecting tube and also to compress the spring; the spring being going to exert force on the propping pin to bias the propping pin outwardly of the connecting tube as soon as the spring is free to stretch;
high-pressure gas from the gas cylinder being going to force the bead to block the middle portion of the axial hole of the connecting tube as soon as the connecting tube breaks at the recess portion thereof, thus cutting off outflow of gas from the gas cylinder.
